(19) United States
(12) Patent Application Publication
(10) Pub. No.: US 2007/0223692 A1
(43) Pub. Date: Sep. 27, 2007

(54) ACTIVATION CONFIRMATION FEEDBACK CIRCUITS AND METHODS

(76) Inventors: Paul Atkinson, Poway, CA (US); Ronald S. Conero, San Diego, CA (US)

Correspondence Address: WILLIAM J. KOLEGRAFF;KESTREL WIRELESS, INC., 15050 AVENUE OF SCIENCE, STE. 230, SAN DIEGO, CA, 92128, US

(21) Appl. No.: 11/550,696

(22) Filed: Oct. 18, 2006

Related U.S. Application Data
(60) Provisional application No. 60/728,391, filed on Oct. 18, 2005.

(51) Int. Cl. H04N 7/167

(52) U.S. Cl. 380/201

(57) ABSTRACT

A circuit and method is provided for confirming that an activation state for a target has been changed. For example, a confirmation signal or message may be generated that a target device has transitioned from a non-operating or deactivated state to an activated state, or that a target device has been deactivated from an operating or activated state. The target may be, for example, optical media or electronic or electrical devices. In one example, the target device is an optical media such as a DVD. The DVD may be deactivated at the time of manufacture and, distributed in a non-playable condition. Upon an authorized sale or other event, a switch in the DVD may be transitioned to an activated state, allowing the DVD to play normally. The switch, which may be an electro-optic or electrochromic material, is monitored for an amount of charge transferred to the switch. By monitoring the total charge or other charge characteristic, it may be confidently determined that the switch has properly changed to its activated state. A confirmation message may then be generated for local or remote use.

### RELATED APPLICATIONS

This application claims priority to U.S. patent application No. 60/728,391, filed Oct. 18, 2005, and entitled “Activation Confirmation Feedback Methods for Optical Media”, which is incorporated herein in its entirety.

### BACKGROUND

1. Field

The present invention relates to circuits and processes for confirming that a target has been successfully activated or deactivated. More particularly, the invention relates to circuits and processes for characterizing a switchable device to provide confirmation that an RF communication caused the switchable device to change state.

2. Description of Related Art

The management of the distribution of products has many challenges. For example, theft is a serious and growing problem, and the protections put in place to reduce theft interfere with product placement, distract from product aesthetics, or irritate the consumer. These anti-theft techniques also add cost and complexity to the distribution process, and unfortunately, have been ineffective in controlling theft. In particular, optical discs and electronic products have been popular targets for theft. Optical discs often hold popular movies, music, games, or software, and are easily stolen at various points in the distribution chain. In a similar manner, electronic devices, such as portable music players, cameras, and televisions are expensive items, and are often stolen. Also, other electronic devices such as razors, toothbrushes, drills, and drills, are also stolen at an alarmingly high rate.

To reduce theft, and to provide timely and accurate distribution information, a new distribution control system has been provided. For example, one such system is described in co-pending U.S. patent Ser. No. 11/295,867, filed Dec. 7, 2005, and entitled “Device and Method for Selectively Activating a Target”, and is incorporated herein in its entirety. The application describes a radio frequency activation (“RFA”) device that enables the activation of a target using an RF communication. The radio frequency activation device has a switch that is initially set to a state that disables or substantially interferes with the use of a target function. Responsive to receiving the RF communication, the switch is set to another state where the function is available. The controlled activation may apply to the target as a whole, or may apply to a selected function, module, peripheral, or component of the target. The radio frequency activation device also has a target interface that allows the target to determine the state of the switch, and based on the state of the switch, either allows or disallows the affected function. The radio frequency activation device also has an antenna for the RF communication, as well as a demodulator/modulator circuit. Advantageously, the disclosed radio frequency activation device enables an RF device to activate an electrical, electronic, or a media target. The radio frequency activation device may be readily incorporated into targets such as electrical or electronic devices, and so enables adaptable manufacturing process and a denial-of-benefit security system. Since the radio frequency activation device may be constructed as commonly used surface mount or DIP packages, the radio frequency activation device may be economically installed in many electronic, electrical, and media devices.

In one example, the “switch” is an optical device. The optical device, may, for example, be an electro-optical or electrochromic stack that is positioned in or on an optical media disc. An optical device, as the term is used herein, affects the ability of either man or machine to perceive or access some aspect of an optical medium. For example, an optical device may make media such as a compact disc (CD), digital versatile disc (DVD) or a high-definition disc (e.g., HD-DVD, Blu-ray Disc) readable or non-readable by blocking, reflecting, deflecting, polarizing, focusing, defocusing, changing the spatial or temporal phase magnitude, affecting the spectral response, inducing a wavelength change of, or otherwise disrupting or interfering with the interrogating light source. In a similar way an optical device may limit or control the recording access of an optical recording or rewritable medium such as a CD-R, CD-RW, DVD-R, or DVD-RW by affecting the recording light source. It will be understood that the disclosed optical device will function on other current and future writable or rewritable media and formats.

Devices to affect the perceptibility of optical media are commonly implemented in configurations in which the device is separate and set apart from the optical media and rather a part of the readout or recording hardware. For instance, mechanical devices can be used to turn on or off the access of a playback or record beam to an optical medium. More elaborate devices can be employed to modify the interrogating optical readout beam in a playback or retrieval device to gain access to optical media with distinctly different resolution requirements (e.g. a CD/DVD switchable player).

It is, however, desirable from both business and hardware compatibility reasons to incorporate an optical device with the optical media as one entity and for the optical device to be switchable by electrical means, allowing for easy integration of logic components for controlling access and security of the optical medium. As detailed in U.S. patent Ser. No. 10/632,047, filed Jul. 31, 2003 and published as U.S. 2004/0022542, such an approach allows for implementation of, for instance, a secure movie rental scheme in which the underlying optical medium is a DVD. Another example detailed in U.S. patent Ser. No. 10/874,642, filed Jun. 23, 2004 and published as U.S. 2004/0257195, allows for denial-of-benefit security; a method of reducing theft of objects by effecting the utility of the object in a way that diminishes its value, and hence the incentive to steal it, until it is paid for, and at which time its utility is restored. In some applications it is desirable and even required that the optical device can be switched from one state to another (e.g. non-readable to readable) only once. In other applications it is desirable or even required that the optical device can be reversibly switched in a repeatable manner between at least two stable states, one state in which the optical medium is accessible, and a second state in which the optical medium cannot be accessed. Furthermore, when the optical device and optical medium are properly designed, access to the content through the optical media should be equivalent or similar to that when no optical device is present, so that modification of the retrieval and/or recording hardware (e.g. the DVD player) is not required. For a given or selected format, such as that of DVD, the optical device-enhanced medium could then be compatible with a large installed base of retrieval or recording hardware.

In one example of implementing the distribution control system, an optical disc is provided with an associated optical shutter. The optical shutter has at least two states. In a first state, the optical media interferes with the ability of an interrogating laser beam to read data from the optical media, and in a second state, the optical media is substantially transparent, enabling the laser beam to read the disc. A powering circuit is used to cause the optical shutter to transition from a first state to the second state. In one example, an integrated circuit acts as the powering circuit, as well as providing logic and processing functions. The power may be received from an associated RF reader, which transmits an RF signal that is received by the integrated circuit. The integrated circuit has conversion circuitry for converting the received RF energy into electrical power for powering the IC's logic and processing functions, as well as providing power to change the state of the optical device. The integrated circuit also couples to an RF antenna, enabling the integrated circuit to communicate with an associated RF scanning device. The optical shutter may take various geometric shapes, and may have an electrochromic or other electro-optic material for facilitating state change. The electrochromic or electro-optic material may fill the shutter, or the material may form a pattern. The shutter may be positioned on the disk so that transition edge-effects are reduced, allowing for reduced interference with the laser beam when the optical shutter is in its clear state. The optical shutter does not cover the entire data area of the disc, and in one example, the optical shutter is quite small, allowing for lower cost production, as well as reducing power requirements to transition the electrochromic material. Power requirements may be further reduced by forming the electrochromic in a pattern. A small optical shutter may disable reading of disc, for example, by placing the small shutter over an important section of the disc, such as the lead-in area.

In a more specific example, the optical shutter is less than 50 square mm in total area, although larger or smaller shutters may be used depending on application requirements. The shutter is positioned over the lead-in area of a disc, and distorts the interrogating laser beam such that the disc player is unable to read the lead-in information. Since this area contains important information regarding the overall content of the disc, the player is not able to effectively read the disc. It will be understood that the shutter may be placed in other positions to obtain desired distortion effects. Further, electrochromic (EC) or other electro-optic (EO) material may be patterned within the shutter, and the shutter and EC/EO material arranged to sufficiently distort the laser when the shutter is in the dark state. In this way, less EC/EO material may be used, enabling faster transitions with less power.

To provide for more robust and confident activation or deactivation of a target, it is desirable to generate a confirmation that the target has been successfully activated or deactivated. This confirmation information may be used locally by a reading device to support a point of sale activity, or the confirmation information may be used to support distribution or payment decisions to support the wider distribution chain.

### SUMMARY

Briefly, the present invention provides a circuit and method for confirming that an activation state for a target has been changed. For example, a confirmation signal or message may be generated that a target device has transitioned from a non-operating or deactivated state to an activated state, or that a target device has been deactivated from an operating or activated state. The target may be, for example, optical media or electronic or electrical devices. In one example, the target device is an optical media such as a DVD. The DVD may be deactivated at the time of manufacture and, distributed in a non-playable condition. Upon an authorized sale or other event, a switch in the DVD may be transitioned to an activated state, allowing the DVD to play normally. The switch, which may be an electro-optic or electrochromic material, is monitored for an amount of charge transferred to the switch. By monitoring the total charge or other charge characteristic, it may be confidently determined that the switch has properly changed to its activated state. A confirmation message may then be generated for local or remote use.

### BRIEF DESCRIPTION OF THE DRAWINGS

FIG. 1 is a diagram of an optical disc in a non-activated state.

FIG. 2 is a diagram of an optical disc in an activated state.

FIG. 3 is an illustration of a modified case for an optical disc.

FIG. 4 is an illustration of a modified case with a non-activated optical disc installed.

FIG. 5 is an illustration of a modified case with an activated optical disc installed.

FIG. 6 is a circuit and block diagram for charge transfer detection for constant current for a confirmation circuit in accordance with the present invention.

FIG. 7 is a circuit and block diagram for charge transfer detection for time-dependent current for a confirmation circuit in accordance with the present invention.

FIG. 8 is a circuit and block diagram for charge transfer detection for time-dependent current, with increased resolution, for a confirmation circuit in accordance with the present invention.

FIG. 9 is a timing diagram for a confirmation circuit in accordance with the present invention.

FIG. 10 is a circuit and block diagram for an H bridge output switch activating a first state, for a confirmation circuit in accordance with the present invention.

FIG. 11 is a circuit and block diagram for an H bridge output switch activating a second state, for a confirmation circuit in accordance with the present invention.

FIG. 12A is a circuit and block diagram for an H bridge output switch, showing the substrate diodes, for a confirmation circuit in accordance with the present invention.

FIG. 12B is a circuit and block diagram for an H bridge output switch, with leakage current isolation diodes, for a confirmation circuit in accordance with the present invention.

FIG. 13 is a single polarity output circuit and block diagram for charge transfer detection for a confirmation circuit in accordance with the present invention.

FIG. 14 is a diagram of an EC film charge characteristic for a confirmation circuit in accordance with the present invention.

### DETAILED DESCRIPTION

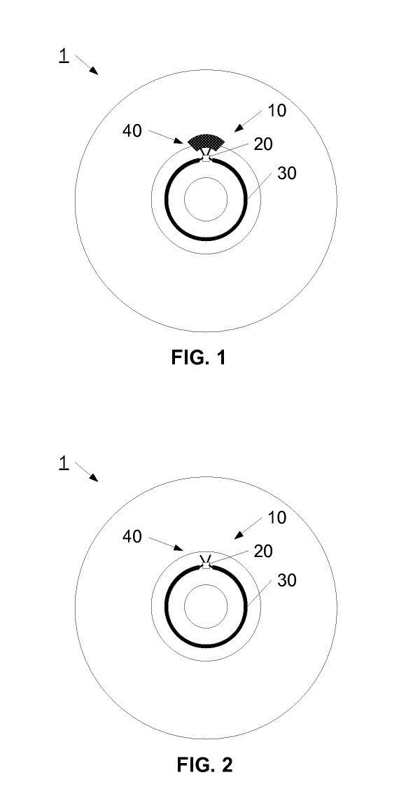

FIG. 1 shows an example of an optical disc 1 in a non-activated state. The non-activated state may be a state where the disc does not properly play in an associated player, or where less than all the disc functions are available for use. The disc may be, for example, a DVD, an HD-DVD, a blu-ray disc, a music CD, a game disc, or a software application disc. Although the invention is described with reference to an optical media, it will be understood that the circuits and processes may be modified for use on electronic products and other types of switches. The optical disc 1 has an optical device 10 coupled to an RFA (radio frequency activation) integrated circuit 20 which is in turn coupled to an communication input interface 30, which is in the form of an RF antenna. The optical device 10 is positioned over data structures or layers 40 which contain the disc contact or the writeable medium. In the non-activated state the optical device 10 (dark circular wedge) is in a state that prevents an interrogating laser beam from reading or writing to the disc. A more complete discussion of the construction and use of optical shutters is provided in co-pending U.S. patent application Ser. No. 11/460,816, filed Jul. 28, 2006, and entitled “Structures and Processes for Controlling Access to Optical Media”, which is incorporated herein in its entirety.

For convenience, in this example, and elsewhere in this application, the optical device may be considered an electrochromic or electro-optic device that can be in either an opaque or clear state relative to the wavelength of the interrogating laser beam, which may be the visual spectrum. It will be understood that other wavelengths may be used. In practice, other optical properties may be manipulated to disrupt the readability or writeability, or affect other optical properties, of the disc. It will also be understood that other switchable materials, compositions, films, or stacks may be used to obtain a desired optical switch effect. Furthermore, the switched state may affect other optical properties of the media such as changing its appearance (e.g. color) to communicate to users the optical disc's state or condition (e.g. the disc is or is not readable). Also, although optical discs are used herein for exemplary purposes the inventions described herein are also applicable to many other forms of optical media or targets with optical properties or features.

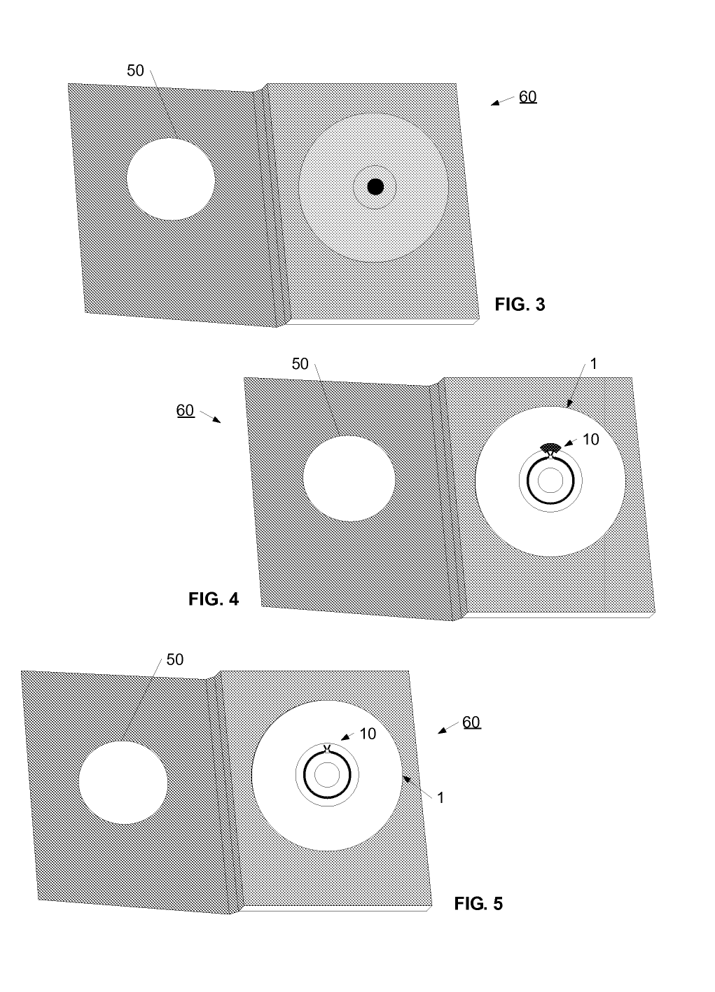

In one example, the disc 1 may have the optical shutter 10 in the opaque state while moved through the distribution chain. The optical shutter appears dark to a human, and also is opaque to an interrogating laser beam. In this way, the non-activated optical disc 1 is an undesirable theft target, as it cannot be played in an associated disc player. Accordingly, the non-activated disc may be subjected to reduced security measures, reducing distribution and retail costs as well as improving the retail experience for consumers. When the disc is purchased or otherwise authorized, an associated reader may send the disc an activation key, which is used by the RFA IC to transition the optical shutter to its substantially clear state, both to an interrogating laser and to a human. In FIG. 2, optical disc 1 has been activated, and the RFA IC 20 has switched the optical device 10 to the alternate optical state which appears clear or slightly translucent to human perception and shown only in the figure with a light gray outline to indicate its presence. To the interrogating laser beam, the optical shutter would be substantially transparent, and would not interfere with optical reading of disc information. As illustrated in FIGS. 1 and 2, the material for the optical shutter may be selected so that the change from the opaque state to the substantially clear state is perceivable to the human eye.

FIG. 3 shows a modified case 60 to enable a visual detection method for confirmation that the disc's optical shutter is in a desired state. An optically clear window 50 has been positioned in the top cover of the case in such a way that when the cover is closed, the window 50 will be allow a direct view of the optical shutter 10 of optical disc 1. In some cases, the window may be concentrically arranged relative to the optical disc. Further, the diameter of the optically clear window 50 is sufficiently large to allow viewing of the optical device on the disc independent of its position on the disc or the orientation of the disc within the case. In some instances, and in particular with targets other than optical discs, a distinctive material such as a reflective or bright label may be placed behind the optical disc or a transparent target, or element thereof, to enhance the ability to determine the state of the target. FIG. 4 shows how a non-activated disc 1 would appear when mounted in the modified case 60. When the cover is closed, the center of the disc would be visible through the circular window 50, and an observer would readily receive visual confirmation that the optical shutter is in its non-activated (opaque) state, and that the disc is not fully functional in an associated player.

FIG. 5 shows the appearance of the optical disc 1 when activated and still in the case. The optical device 10 has been changed to its transparent state, which is visible through window 50. Note that this will also be true if the cover of the case is closed, since the circular window is concentric to the optical disc, and large enough to allow external viewing of the optical shutter. Any rotational position of the optical disc in the case is allowed. The position of the optical disc 1 relative to window 50 will change based on the rotational alignment, but the state change from opaque to clear, in the example, will always be visible whether the case is closed or open. It should also be apparent that the case cover or the entire case could be made clear, rather than having a window in the cover and the user could simply look all the way through the case when the optical disc switches state. When the cover is closed, an observer would readily receive visual confirmation that the optical shutter is in its activated (substantially clear) state, and that the disc is fully functional in an associated player.

Visual detection may not practical in some situations, and it may not be sufficiently reliable or effective to support robust applications related to the activation. A business model based on collecting payment after a successful activation at the retail check-stand for example is much faster and more reliable without having to rely upon human intervention. Accordingly, an electronic detection circuit and process is described.

A method for electronically determining the state of the switch is described herein. This method uses a basic operational characteristic of the optical shutter, that to switch states, the optical device accepts charge from the RFA IC. By characterizing the charge requirements of the optical device, and then measuring the charge actually applied to the optical device during an activation or deactivation event, it may be confidently determined if the optical shutter has properly changed states. Unless the optical device or its associated circuitry is defective, if the optical device accepts the requisite charge, then it is almost a certainty that the optical device has changed state. After measuring the charge conditions and confirming a proper charge has been transferred to the optical device, an electronic feedback signal can be provided via the RFA IC to the reader and other entities such as the cash register. The confirmation feedback message may be used locally to inform a clerk or consumer that the optical shutter has properly switched, or may be used to support distribution or accounting functions on a store-wide or network basis. The method described below can be used to determine if the optical device is accepting charge consistent with the desired outcome.

The amount of charge required to switch the optical device is a function of the optical device area, material, and overall device structure. For example, the larger the optical device area, the greater the charge required to switch its state. The optical device also requires a certain threshold voltage to be applied before any charge can be transferred. Once this threshold voltage is exceeded, current may flow into the optical device, which transfers charge as a function of current and the time. The amount of charge Q transferred is the product of the current I, and the time T, or Q=I*T, if I is constant over the interval T. If I varies over the interval T, then the charge transferred is given by: Q=∫ I dT over the interval T. Thus, if the RFA IC can measure the voltage across the optical device and the current flowing into the optical device over the interval T, then the total charge transferred can be either directly calculated, or inferred by ensuring it is over certain thresholds for some time interval. If the total charge transferred is above a target value, then a feedback signal may be sent from the RFA IC to the reader (and other communicatively coupled devices), to indicate that the optical device successfully switched, and the optical disc has been activated.

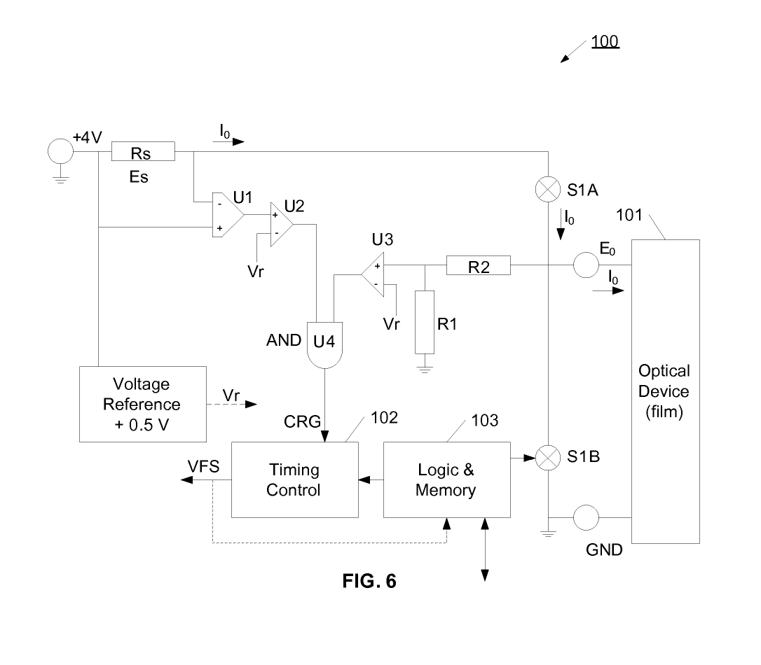

If the current Io to the optical device 101 is constant during the activation interval, the charge to the optical device 101 may be detected and monitored by the circuit diagram 100 shown in FIG. 6. In this FIG. 6 only the output stage, and the circuitry necessary to describe the function of the detect charge transfer is shown. It will be appreciated that other circuit elements and interconnections will be used, but are well known to one skilled in the art. It will also be understood that circuit 100 may be preferably incorporated into the RFA IC discussed earlier, or may be separately or discretely arranged. Referring yet to FIG. 6, the optical device 101 is connected to the optical device at terminals Eo and GND. S1A and S1B are complementary switches that connect terminal Eo either to GND when S1B is on, or to +4V through Rs, when S1A is on. S1A and S1B are always in opposite states except when the RFA IC is un-powered, in which case they are both off.

The +4V supply provides power for an internal voltage reference Vr, which is shown as +0.5V in the figure, but could be any voltage lower than the lowest supply voltage expected during normal operation. The reference voltage Vr is used as the comparison voltage for comparators U2 and U3. In actual practice, the +4 V voltage supply should be current limited to a low value, such as 2.25 mA. This acts to keep the initial current that the optical device draws from overloading the 4V supply, and causing it to collapse, or the RFA IC logic from resetting.

The output voltage Eo is divided down by resistors R1 and R2 and applied to one input of comparator U3. The ratio is chosen so that output Eo must be above a certain voltage in order for the output of comparator U3 to be high (True). This voltage, for example, might be set for +2.5V. If the output voltage falls below +2.5V for any reason, the output of U3 will go low.

The output current Io flows through resistor Rs and develops a voltage Es which is amplified by the gain A1 of differential amplifier U1, and applied to one input of comparator U2. The actual voltage at U2 is given by: E=Io*Rs*A1. If this voltage is above the comparator threshold of +Vr, then the output of comparator U2 will be high (True). Resistor Rs and the gain A1 are chosen to set the current required for proper detection. As an example, if the desired current threshold is 2 mA, then Rs=100Ω and A1=2.5 will give a voltage at the output of U1 of 0.5V, the exact value for the reference voltage. Thus, as long as the current Io is greater than 2 mA, the output of comparator U2 will be high. Note that amplifier U1 can also be used to implement the current limiting function of the 4V supply, and is likely to be part of the 4V supply circuit. Further, the current limit value of the supply (2.25 mA in this example), should be slightly higher than the 2 mA sensing threshold of comparator U2.

If both comparator outputs U2 and U3 are high, the output of AND gate U4 will go high indicating proper current Io and voltage Eo are being applied to the optical device. The CRG signal at the output of U4, is applied to the timing control circuit 102. When the IC commands the optical device 101 to switch, the logic and memory circuit 103 turns on switch S1A, and turns off S1B, and also sends a start signal to the timing and control circuit to start a timer. This timer monitors the CRG line for a pre-determined time, for example, 1 Sec. If the CRG line remains high for the entire time interval, then an output signal, VFS is asserted which indicates successful charge transfer to the optical device has occurred. This VFS (Verified Film Switched) signal is then passed to the reader via the logic and memory circuit of the IC.

In this example the total amount of charge transferred is given by Q=Io*T, where Io is a constant value of 2 mA for the 1 second period. Thus, Q=2 m Coulombs. Note that in reality, 2.25 mC of charge has been transferred since the current limit is set to 2.25 mA. However, the current monitor circuit threshold is set for 2 mA, so it can only indicate that at least 2 mC of charge has been transferred.

If the logic and memory 103 circuit monitors the output of U2 and U3 directly, then the various states shown in Table 1 can be detected. The table assumes that Io and Eo are measured at the start of the 1 sec timing interval. At the end of the 1 sec interval, the logic and memory circuit may send a signal back to the reader that indicates switching was not successful, and a error code can also be sent which indicates the failure mode of the optical device, for example, either Open or Shorted. Conversely, if the charge transfer is normal, then a code or message indicating a normal switch function can be sent to the reader.

TABLE 1
IC Output State Conditions.

| | | | | |
|---|---|---|---|---|
| Switch S1A | Switch S1B | Io | Eo | optical device |

| | | | | | | |
|---|---|---|---|---|---|---|
| Off | On | 0 | | 0 | | Non-activated |
| On | Off | 0 | | >2.5 | V | Open |
| On | Off | >2 | mA | 0 | | Shorted |
| On | Off | >2 | mA | >2.5 | V | Normal |

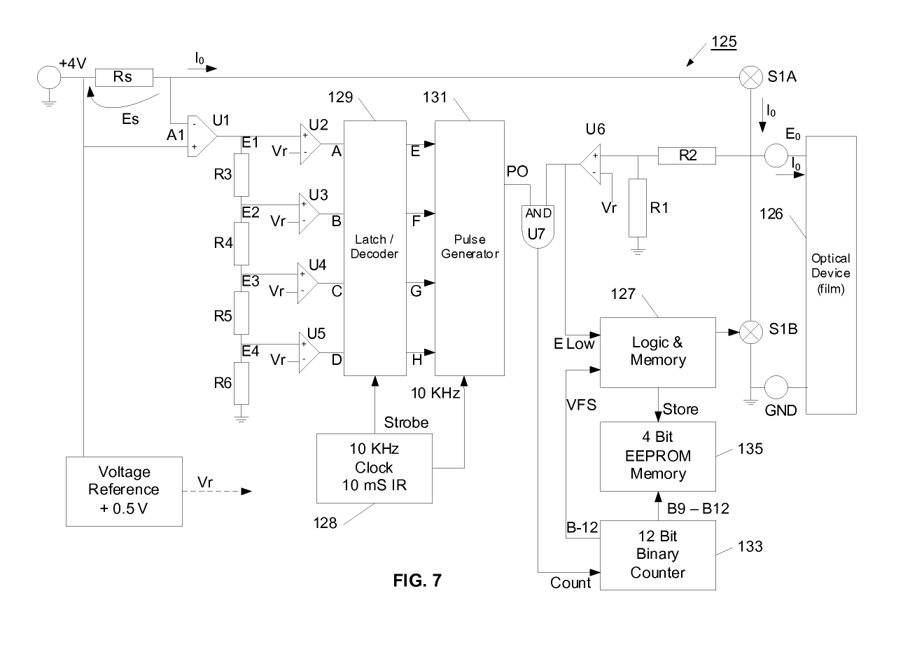

In some cases the current, and hence the charge being transferred to the optical device, is not constant, but changes over time. In this case, it is desirable to integrate the current over the time interval in order to measure the actual charge transferred. One approach to this problem is shown by the block diagram 125 in FIG. 7. As in FIG. 6, the output voltage Eo is sensed through the divider R1, R2, and compared to the reference voltage Vr by comparator U6. The output of the comparator, E low, connects to both AND gate U7 and the logic and memory circuitry. As before, the R1/R2 divider sets the voltage threshold to +2.5V. As long as the output Eo is above this threshold, the output of comparator U6 will be high.

The output current Io is sensed by Rs and amplified by differential amplifier U1 by gain A1. The scaling is set so that 1 mA of output current equates to an output voltage of 1V at U1's output. The maximum current to be sensed is 3.5 mA, in this example, which equals 3.5V at U1's output. Note that the supply voltage is assumed to be +4V. U1's output is divided by resistors R3 through R6 and applied to voltage comparators U2 through U5. The comparators reference voltage is Vr (0.5V). The resistive divider is set so that U2 will detect Io>0.5 mA, U3 will detect Io>1 mA, U4 will detect Io>2 mA, and U5 will detect Io>3 mA. In this example, divider ratio R4=R5=R6, and R3=3*R4. The outputs of comparators U2 through U5 are signals A, B, C, and D. A truth table is shown in Table 2. which shows the relationship of these signals to the input current.

TABLE 2
Comparator Outputs versus Current Io.

| Io | | D | C | B | A |
|---|---|---|---|---|---|
| 0 | mA | 0 | 0 | 0 | 0 |
| ½ | mA | 0 | 0 | 0 | 1 |
| 1 | mA | 0 | 0 | 1 | 1 |
| 2 | mA | 0 | 1 | 1 | 1 |
| 3 | mA | 1 | 1 | 1 | 1 |

When the optical device 126 is to be switched, the reader will send out a constant RF carrier for a known time interval T. As an example, T could be 1 second. The actual interval will be a function of the optical device and the charge required to switch it. The start of the interval T is controlled within the IC by both the logic and memory circuit 127, and the 10 KHz Clock circuit 128. The clock circuit 128 incorporates a timer that sends out a strobe pulse every 10 mS to the latch decoder circuit 129. The latch decoder circuit 129 reads the state of the comparator signals A, B, C, and D, and stores them in an internal register. A built in decoder decodes the states and provides stable outputs E, F, G, and H. These outputs are stable for 10 mS until the next strobe pulse updates them. Table 3. shows the decoded states versus input current Io.

TABLE 3
Decoded Outputs versus Current Io.

| Io | | H | G | F | E |
|---|---|---|---|---|---|
| 0 | mA | 0 | 0 | 0 | 0 |
| ½ | mA | 0 | 0 | 0 | 1 |
| 1 | mA | 0 | 0 | 1 | 0 |
| 2 | mA | 0 | 1 | 0 | 0 |
| 3 | mA | 1 | 0 | 0 | 0 |

Note that only one of the outputs is true at any one time, for the various input current values. These decoded signals thus represent the input current for a single 10 mS time interval. They can change states every 10 mS if the input current Io changes. The decoded outputs H, G, F, and E are read by the pulse generator 131 circuit, which puts out a serial pulse train at output PO. The pulse generator circuit 131 uses a 10 KHz signal from the clock circuit 128 to generate these pulses. The number of pulses generated at PO is a function of the input current Io. The relationship of output pulses to Io is shown in Table 4.

TABLE 4
PO Pulses versus Current Io.

| | | | | | | PO | |
|---|---|---|---|---|---|---|---|
| Io | | H | G | F | E | 10 mS | |
| 0 | mA | 0 | 0 | 0 | 0 | 0 | Pulses |
| ½ | mA | 0 | 0 | 0 | 1 | 5 | Pulses |
| 1 | mA | 0 | 0 | 1 | 0 | 10 | Pulses |
| 2 | mA | 0 | 1 | 0 | 0 | 20 | Pulses |
| 3 | mA | 1 | 0 | 0 | 0 | 30 | Pulses |

The amount of charge transferred within a 10 mS interval is the Current Io (assumed to be constant for the interval), multiplied by the interval T (10 mSec). As an example, if the current were 1 mA, then 10 uCoulomb will be transferred during the 10 mSec interval. As Table 4 indicates, this is represented by sending 10 pulses out of the pulse generator circuit 131 on the PO output line. Thus, 1 pulse on the PO output represents 1 u Coulomb of charge. The pulses are always clocked out at the 10 KHz clock rate. Only the number of pulses varies. The pulse output line PO is routed through AND gate U7. If the voltage output Eo is greater than +2.5V, the pulses will pass through the AND gate to the 12 Bit binary counter circuit 133. If the voltage Eo is low, no pulses will be sent to the 12 bit binary counter circuit 133. The 12 bit binary counter circuit 133 functions as a digital integrator. It accumulates the pulses from the pulse generator circuit 131 for each 10 mSec interval of the overall time interval T, which is 1 Sec. in this example. There are therefore 100, 10 mSec intervals within interval T. The maximum count that could be accumulated is 100*30, or 3000 counts. The 12 bit binary counter 133 is capable of counting to 4095 counts. If the current were constant at 2 mA, the PO output would send out 20 pulses for each of the 100, 10 mSec intervals, and a total count of 2000 would accumulate in the 12 bit binary counter 133. This would represent a total charge of 2 m Coulombs. However, if the current changes, the number of pulses accumulated for each 10 mSec interval varies, but the digital integrator will sum up the total number of pulses for all 100 intervals. This accumulated number is directly proportional to the area under the Io versus T curve, and represents the total charge Q transferred in time T.

In order to sense successful charge transfer, and therefore successful switching of the optical device, the total accumulated count in the 12 bit binary counter 133 must be compared to a target value. As an example, suppose 1.5 mC were required to switch the optical device. Good design practice would build in some safety margin, so setting the target at 2 mC or higher would be acceptable. For the 12 bit binary counter 133, bit 12 represents a total count of 2048 counts, i.e. 1000,0000,0000 in binary. Therefore, if the B12 line goes high, there has been at least 2.048 m Coulombs of charge transferred. The B12 output of the 12 bit binary counter is named VFS (Verified Film Switched), and is routed to the logic and memory circuit 127 of the IC to signal successful charge transfer. The logic and memory circuit 127 will send this information on to the reader, where it can be locally used or transmitted to network resources.

If the RF carrier is lost during the interval T, the IC may power down and the amount of charge transferred up to that point may be lost. The logic and memory circuit 127 monitors both the supply voltage, and the output voltage Eo via the Elow input from comparator U6. If power drops, the logic and memory circuit 127 sends a store command to a 4 bit EEPROM memory circuit 135. This causes the upper 4 bits of the 12 bit binary counter circuit 133, namely B12, B11, B10, and B9, to be stored in non-volatile memory. Because only the upper 4 bits are stored, the total charge accumulated will only be known to within 0.256 m Coulombs. However, this is less than the safety margin of 0.548 m Coulombs. (2.048−1.50) When power is re-acquired, the logic and memory circuit 127 will read the 4 Bit EEPROM memory 135 in order to know how much charge was transferred before the power loss event. The newly accumulated charge data will be added to this stored value once power is restored, and used to compare against the target value required for activation. In this way, the system becomes tolerate of power dropouts in the RF link. Note that the error of 0.256 mC can be reduced by storing more than 4 bits.

The circuit 125 shown in FIG. 7 to measure the current is essentially a current-to-voltage converter formed by Rs and U1, followed by a simple 2 bit Analog/Digital flash converter. Flash converters are typically used in very high speed applications, and require many comparators for even modest resolution (2ˆN comparators for N bits of resolution). In addition, the pulse generator will become more complex with increased resolution. Thus, if more resolution is required in the charge measurement for this application, this type of converter will consume too much power and chip real estate to be practical in some cases.

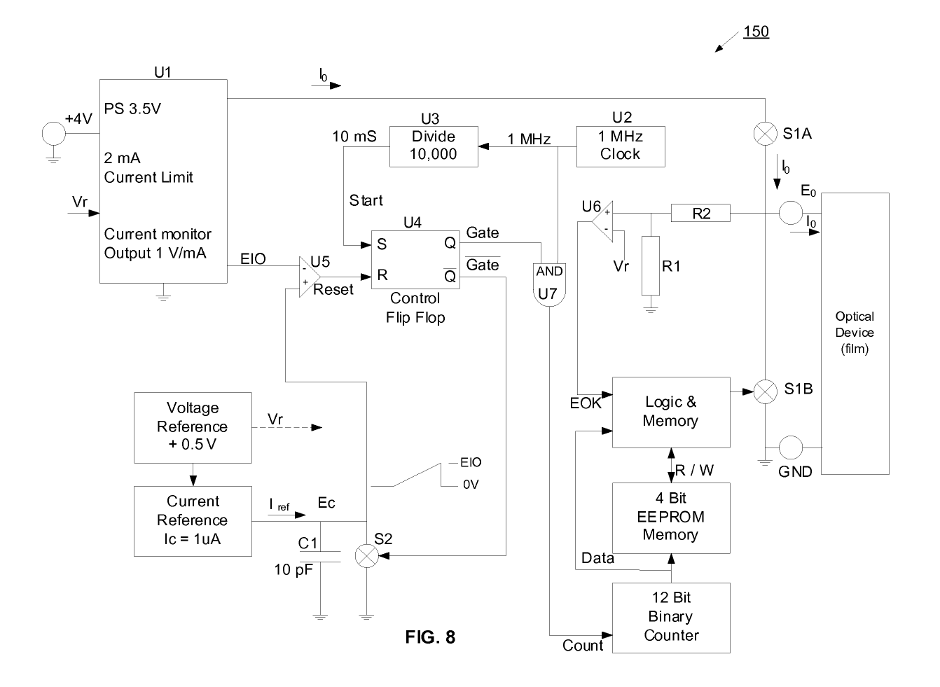

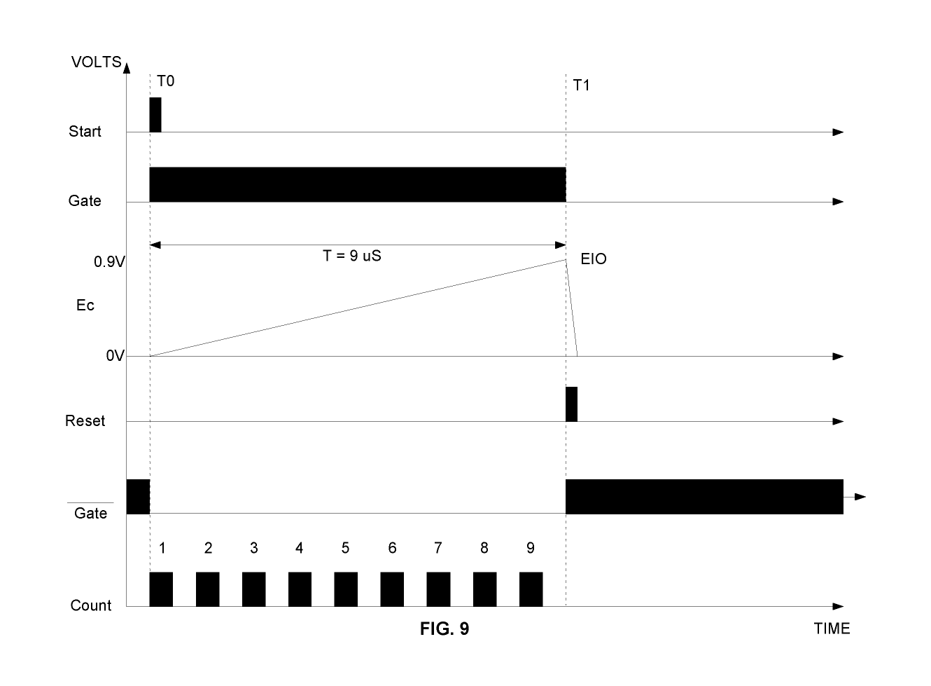

An alternate Analog/Digital conversion approach 150, capable of 5 bit resolution per 10 mS conversion cycle, is shown in FIG. 8. In FIG. 8, the voltage sensing, and pulse accumulation is similar to that previously described in FIG. 7. The way in which the current Io is converted to digital pulses is quite different and will be described with the aid of the waveforms shown in FIG. 9. In FIG. 8 the power supply for the output stage U1, provides a constant output voltage, (3.5V in this example), at any current between 0 and 2 mA. When the current reaches 2 mA, the supply current limits so that it cannot be overloaded by high initial current demands from the optical device. In addition, the power supply provides an output voltage, EIO, which is proportional to the actual load current Io. This output is scaled at 1V per mA, so at Io=2 mA, EIO will be 2V.

A single slope integrating A/D converter made up of reference current source Iref, capacitor C1, switch S2, and functional logic elements, U2 through U7, then converts this voltage, EIO, into a proportional number of output pulses at the COUNT output of U7. U2 functions as the master clock for the converter, and runs at 1 MHz, or a 1 uSec period. Its output is connected to AND gate U7, and clock pulses will pass through U7 to the 12 bit binary counter, whenever the GATE line is high. The clock also is connected to U3, which divides the clock down to 100 Hz. This signal, which occurs every 10 mSec, generates the START pulse for the converter. It is applied to the Set input of the control flip flop U4. Since the START pulse occurs every 10 mSec, the converter will sample EIO 100 times a second.

Prior to a conversion, U4 is in its reset state, and the GATE output is low. U7 is gated off, and the COUNT output from U7 remains low. The NOT GATE signal is high, and turns on switch S2. Switch S2 holds the voltage EC across C1 at zero volts, and provides a sink path to ground for the precision reference current, Iref. Since EC is zero, the RESET line will be low. Thus, U4 is in a stable state and the converter remains in this condition until a START pulse occurs at the Set input of U4.

When a START pulse is received, the GATE line goes high and enables U7 which allows clock pulses with a 1 uSec period to accumulate in the 12 bit binary counter. The NOT GATE output of U4 goes low, which turns off switch S2. This allows Iref to charge capacitor C1. Since the current is constant, C1 charges with a linear ramp whose slope is given by: dV/dT=Iref/C1. For example, if Ic=1 uA and C1=10 pF, then the slope of the ramp is 0.1 V per uSec. C1 charges until the voltage across it, EC equals the voltage to be measured, EIO. As soon as EC exceeds EIO by just a few millivolts, the RESET line goes high and resets flip flop U4. When U4 resets, the GATE line goes low which inhibits clock pulses to the 12 bit binary counter. The NOT GATE line goes high which turns on S2. S2 now discharges C1 and shunts the reference current, Iref, to ground. When EC falls below EIO, the RESET line goes low.

The time for the capacitor C1 to charge up to the input voltage EIO is: T=EIO*C1/Iref. Thus the charge time is proportional to the input voltage EIO, which in turn is proportional to the output current Io. The GATE output of the control flip flop will be high for T seconds. Its width, T, will be proportional to current Io. For example, if Io=2 mA, and EIO=2V, then T=20 uSec. Since the 1 MHz Clock generates 1 pulse every uSec, 20 pulses will be generated during this conversion at the COUNT output, and accumulated in the 12 bit binary counter.

As a practical limit, EIO could be allowed to go as high as 3.2V. Since the converter can resolve 0.1 V, which represents 1 pulse, it has a resolution of 1 pulse out of 32, or 5 bits per 10 mS conversion cycle. This resolution represents a current of 0.1 mA which is equal to 1 uC of charge transferred to the optical device during the 10 mSec sample interval, assuming that the current remains constant over the 10 mSec interval. Note that the actual conversion time for the A/D converter is proportional to the input voltage EIO, and can have a maximum value of 32 uSec. If 3.2 mA were to flow into the optical device for 1 Sec, then 32 pulses would accumulate in the 12 bit binary counter every 10 mSec giving a total accumulated count of 3200 for the 1 Sec interval. Note that the counter has a maximum count capability of 4095 counts (2ˆ12). Since 1 uC out of 3200 uC can be resolved for the entire charge transfer cycle, the A/D system effectively has better than 11 bit resolution for the total integrated charge measurement.

In order to reliably switch the optical device, a certain amount of charge generally must be transferred. It will be understood that the exact amount of charged needed may vary device to device, and may vary depending on the particular construction of the optical device. To more reliably generate a confirmation signal, it is generally desirable to measure a sufficient charge transfer to allow for device-dependent and measurement differences. As an example, suppose 1.8 mCoulombs is a sufficiently safe charge, and the current is limited to 2 mA. For each 10 mSec interval, 20 uC of charge will be transferred. In 90 such intervals, 1800 uC, or 1.8 mC of charge will be transferred. This will take 90×10 mSec, or 0.9 seconds. At the end of this interval, the 12 bit binary counter will have a count of 1800. Once the optical device has switched, the current Io will fall to zero, no further charge will be transferred, and no further counts will be accumulated in the counter.

When the RFA IC initiates an activation sequence to switch the optical device, the logic & memory circuit turns on S1A, and turns off S1B, and also enables the 1 MHz clock U2, and the divider U3 that generates the start pulses for the A/D converter. Because the output current is limited to 2 mA, the output voltage Eo to the optical device will be a function of the state of charge of the optical device itself. At some point during the transfer of charge to the optical device, Eo will reach the maximum supply driving voltage, (+3.5V in this example). This condition is sensed by the R1/R2 divider and comparator U6, which sends logic signal EOK to the logic & memory circuit when Eo passes a defined threshold, such as +3.25 V. The logic and memory circuit also keeps track of the elapsed time since the beginning of the activation sequence. Once a predetermined amount of time has elapsed, such as 1000 mSec, it will inhibit U2, and U3, which will stop further pulses from accumulating in the 12 bit binary counter. At the end of this activation sequence, which in this example lasted 1 second, the 12 bit binary counter has an accumulated count that represents the total amount of charge transferred into the optical device. The logic and memory circuit compares this total to a previously defined target criteria, and makes a decision if activation has been successful. The target criteria requires that EOK be true, that the accumulated count be in a normal range, and that the total elapsed time for switching is also in a normal range. This decision result is sent to the reader for confirmation of successful activation. The logic and memory circuit also stores the data, representing the total charge transferred, in EEPROM memory. This provides the ability to interrogate the RFA IC later and recall the amount of charge delivered to the optical device. This provides a way to confirm that activation has occurred by means of the RFA IC, as opposed to external connection to the optical device.

Alternate criteria can be used to determine that the optical device has switched. If a certain amount of time has passed, say 0.85 seconds, the total count in the 12 bit binary counter is 1700 or more, EOK is true, and the current Io goes to zero, it may be concluded that the optical device has accepted all the charge it can. If this charge is within the acceptable target range, a successful activation decision can be made early. It is not necessary to wait a full second. Other criteria may also be possible.

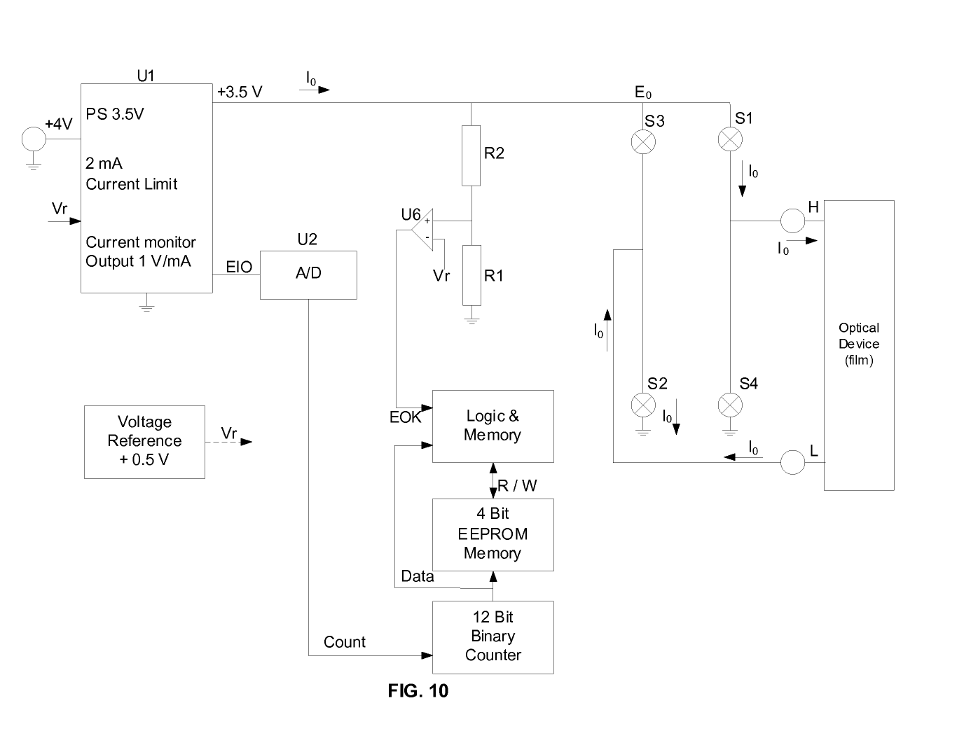

There may be a class of optical devices that can be de-activated, as well as activated. It is desirable to be able to sense, confirm, and report successful de-activation. Assuming that measuring the charge transferred out of the device is a viable method for doing this, the circuit of FIG. 8 may still be utilized by simply changing the output switch configuration to an H bridge arrangement as shown in FIG. 10. In this FIG. 10, the A/D converter has been shown as a single block element to simplify the drawing. Switches S1 to S4 form the H Bridge. During activation, the logic and memory circuit turns on switches S1 and S2 and turns off S3 and S4, which causes current Io flow into terminal H of the optical device. Note that terminal H is positive with respect to terminal L. Once complete charge transfer has occurred, the total count in the 12 bit binary counter may be transferred to EEPROM memory.

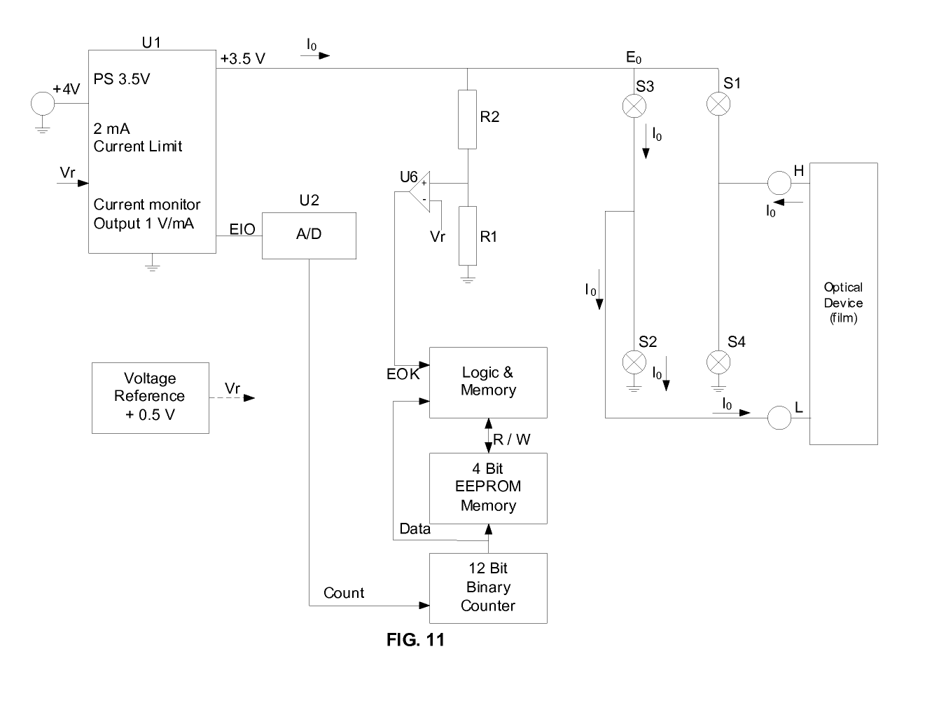

When de-activation is required, it is typically necessary to reverse the current flow to the optical device. In this case, the logic and memory circuit turns on S3 and S4, and turns off S1 and S2 as shown in FIG. 11. This causes the current Io to flow out of terminal H of the optical device, which reverses its state. Note that terminal L is now positive with respect to terminal H. The polarity across the optical device has been reversed. In one example, voltage sensing may be done on the top side of switches S1 and S3 in order to simplify the circuit. The S1/S3 voltage is a close representation of the voltage across the optical device. It is only different due to the current Io flowing through the switch impedance; which is likely to be only about a 20 mV error. Note that the direction of current Io from the power supply U1 is the same. This means that no changes are required in the measurement circuit to measure the reversed current flow in the optical device.

Once de-activation is complete, the total count in the 12 bit binary counter is transferred to EEPROM memory, but in a different location from the activation total. This allows comparison of the charge required to de-activate the optical device relative to the charge required to activate it originally. One criterion to judge successful de-activation may be that these two numbers match within a defined tolerance. It will be appreciated that other comparisons may be useful, and the comparison to threshold values may also be used. It will also be understood that the deactivation/activation process may be substantially symmetrical, or may have different charge requirements. In another example, the threshold voltage for activation switching may be different from the threshold voltage for deactivation switching.

The electrochromic (EC) or electro-optic (EO) devices typically used with the circuits presented in FIGS. 6 thru 11, fall into 2 general classes: single polarity non-reversible films, and dual polarity reversible films. These two classes of films utilize different chemistries and materials to achieve these behaviors, and as such may exhibit different electrical characteristics from one another in the un-activated and activated optical states, as well as the transitions between the states. It will also be understood that other types of optically switchable films or materials may be used. For example, metal compositions may be used to affect reflectivity or other optical characteristic. For purposes of discussion, all these types of optically switchable compositions and materials will be referred to as EO/EC films. The EC/EO films change state by transferring charge regardless of the class, and by monitoring charge transfer with the circuits described in FIGS. 6 thru 11, activation can be confirmed for both classes of EC/EO films.

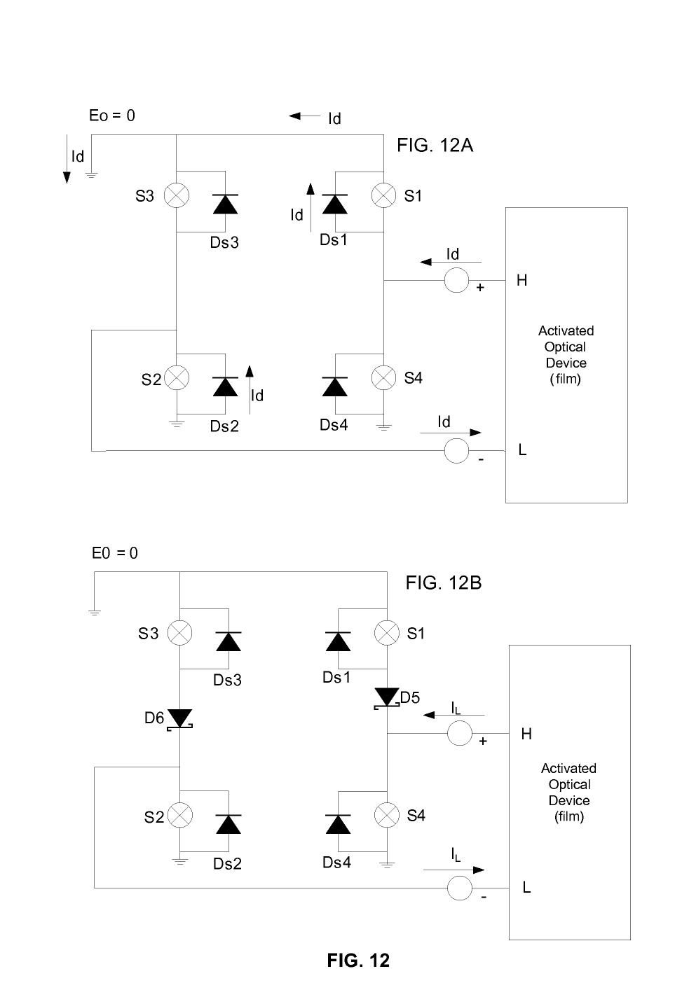

The reversible EC/EO film acts similar to a charged capacitor when it is in the activated state. FIG. 12 shows an optical device using an EC film, and with the EC film in its activated state (substantially clear). In FIG. 12A, the circuit is shown without leakage protection, while FIG. 12B adds current leakage protection components. There is typically a voltage potential between the H and L leads of the EC film. If not managed, this potential may cause an undesirable leakage current to flow thru the substrate diodes when the device is powered off, which would transfer charge from the EC Film. Such a charge depletion may cause the EC film to transition to a rest or more opaque state if there is a path for sufficient current to flow. In this way, the activated optical device may undesirably transition over time to a state that would make the disc unplayable. The circuit of FIG. 12B is useful to reduce this undesirable charge leakage due to forward biased substrate diodes driven by EC film potential.

When the RFA IC is not powered by RF energy, the supply voltage goes to zero on the output stage and effectively shorts the Eo line (the supply line) to ground (as illustrated). Switches S1 thru S4 in the H bridge output stage are FET type switches for CMOS IC's. Due to the physical construction of the IC, there are substrate diodes Ds1 thru Ds4 across each of these switches with the polarity as shown in FIG. 12. Typically these diodes are reversed biased during normal power-on operation of the circuit and do not conduct current. When power is removed, however, the potential across the film has a current path thru substrate diodes Ds1 and Ds2 which discharges charge from the EC Film as illustrated in FIG. 12A. This current, shown by the arrows labeled Id, actually forward biases the two diodes Ds1 and Ds2, and cause the potential across the EC Film to discharge down to approximately 1.2V. Since 3.0V to 3.5V is typically required to keep some EC films in the charged state, the film may change to its opaque state, or may transition of some other undesirable rest state. Note that this condition may also occur in a single ended output stage as shown in FIG. 6. In that case, only one substrate diode becomes forward biased, and the voltage across the EC Film is reduced down to 0.6V. Even if the output switches were not within the IC, the undesirable discharge may still exist because even discrete FET switches still incorporate substrate diodes. A circuit and process to avoid or manage such undesirable discharge is described in detail in co-pending U.S. patent application No. 60/807,387, filed Jul. 14, 2006, and entitled “Reduced Leakage EC Film Driver”, which is incorporated herein in its entirety.

FIG. 12B has another circuit for avoiding or managing undesirable discharge from the EC film. FIG. 12B shows a modified H bridge output driver which isolates the substrate diodes from loading the EC Film via the addition of very low leakage current Schottky diodes D5 and D6. Examination of the circuit in FIG. 12B shows that the current Id in FIG. 12A, which flowed thru substrate diode Ds1, can no longer do so because diode D5 is reversed biased. Diode Ds4 is also reversed biased, so the only charge that flows from of the EC Film is a very small diode leakage current IL. This current can be made so small that the EC film maintains its charged or activated state for a desired length of time. Since the output circuit is an H bridge, the EC film may be switched to the alternate polarity. In this condition diode D6 provides the isolation, and the EC film is maintained in the non-activated or opaque state. It is important to note that if diodes D5 and D6 are incorporated within the RFA IC, they should be fully isolated from the substrate of the IC.

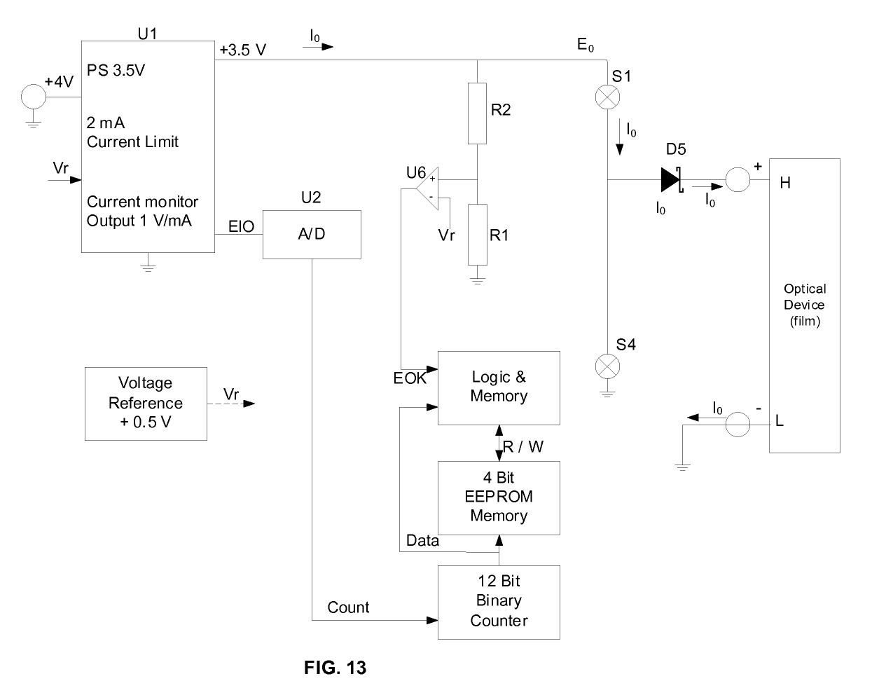

FIG. 13 shows the application of a low leakage Schottky diode for leakage current isolation for a single polarity output driver stage. FET switches S1 and S4 have substrate diodes across them (not shown) which can discharge the EC Film when the IC is powered down. Diode D5 prevents any substantial reverse current flow into the output stage. In both FIGS. 12B, and 13, the isolation diode(s) will reduce the voltage available to drive the EC Film by approximately 0.35V. This drop represents only 10% of the required drive voltage for the EC Film, and may be compensated for by raising the supply voltage by an equal amount.

Because the EC Films are chemical devices that switch states based on charge, there is inherent variation in the devices due to process variations during manufacture. The variations basically affect the amount of charge required to switch the EC Film to the activated state. Within a production lot, the unit to unit variation may be as much as 10% for the 3 sigma limit. Lot to lot variation may, in some cases, have more or less variation. Further, different media may use different EC/EO films, and changes in EC/EO films over time may result in many different films being in the distribution chain.

To allow for more effective activation and deactivation processes, the detection and confirmation circuits may be adapted to the charge requirements for a particular switch device or a particular class of switch device. For example, the detection processes may be adapted to account for EC/EO process variations. The EC/EO films typically have a similar method for determining when they have fully charged to the desired state: the current flowing into the film decreases to a very low value, which is related to the film's self leakage current. This leakage current will be very low compared to the normal charging current. As an example, if the charge current is 2 mA, the leakage current may be 100 uA or less. It is important to note that driving the EC Film with a current limited drive circuit set at 2 mA, does not mean that the current is always 2 mA. It may be at or near the 2 mA level during the first part of the charge cycle, but as the EC/EO film charges, the current goes down due to the impedance change of the EC/EO film itself. As the film charges, it reaches a point where the film simply will not take any more current, except for its leakage current. So, by monitoring when the current reduces to 100 uA or less, it may be determined that the EC/EO film is fully charged. The amount of charge that transferred can be measured by any of the circuits presented. For instance, in FIG. 13, the charge is accumulated in the 12 bit binary counter. The actually current Io that flows is represented by voltage EIO, which is scaled 1V/1 mA. The resolution is 0.1 mA, or 100 uA. This current is available to the logic and memory circuit every 10 mS once the activation interval starts. By monitoring when the current reduces to 100 uA or lower for several 10 mS intervals, the circuit may detect when the EC/EO film is fully charged. At that point, the number accumulated in the 12 bit binary counter represents the amount of charge that was transferred during the activation cycle. In addition the system has knowledge of how long a time it took for the EC film to charge. It can determine this by simply counting the number of 10 mS cycles required for the current to go to reduce below the defined threshold.

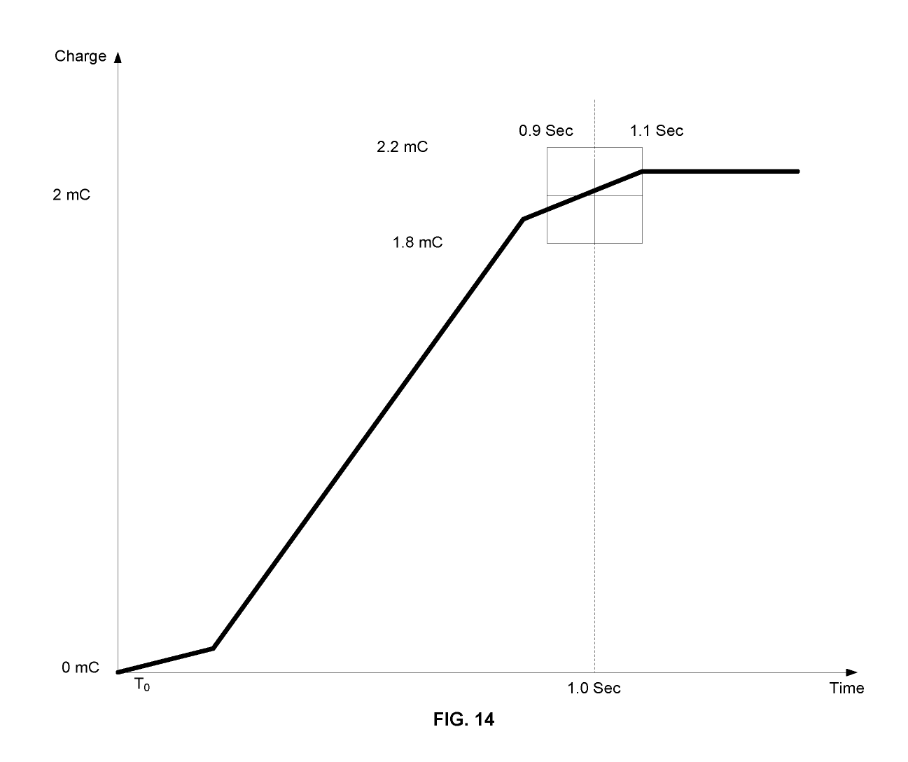

The EC film manufacturer can do sample testing of each production run or lot in order to determine the specific operational limits of that lot. For example, suppose a lot of 100,000 units is manufactured and then characterized. It is found that the mean charge required to switch the device is 2 mC with a standard deviation of 0.05 mC. The time for switching to occur had a mean of 1 sec with a standard deviation of 25 mS. The manufacturer would then calculate the 4 sigma limits for the lot and supply that data with the lot of film. FIG. 14 shows the minimum and maximum limits for the example described. Thus, for this lot, almost all of the units will switch between 0.9 sec and 1.1 sec, and will require between 1.8 mC to 2.2 mC. In general, there is probably a strong correlation between the time to switch and the amount of charge required to switch. Note that 4 sigma limits mean only 63 unit out of 1 million will lie outside this range. For the limits to hold, the lot sampling should have the same level of confidence. This data is supplied to the RFA IC manufacturer as 4 data points, Tmin, Tmax, Qmin, and Qmax which are then programmed into the logic and memory circuit block of an equal number of RFA IC's. During manufacturing, the EC films from this lot are correlated to the RFA IC's of the same lot number and incorporated into the optical media. Thus, once the EC film is activated, the circuit compares the time it took to switch, (the charge current went to zero) and the amount of charge that was transferred, (total accumulated in the 12 bit binary counter) to these stored values. In the example shown in FIG. 14, if the time to switch was between 0.9 to 1.1 Sec, and the accumulated charge was between 1.8 to 2.2 mC, then successful activation would be indicated.

If a problem exists that prevents the EC Film from accepting charge, it is not necessary to wait for the entire 1.1 sec interval. During activation the RF reader is providing a constant RF carrier in order to supply the power to switch the film. During this interval, the reader can still listen for backscatter signals from the RFA IC. For example, if the current stays at zero for the first 100 mS of the activation interval, the logic and memory circuit can send out an error message to the reader indicating this state. It may be possible to detect several different problems and send back unique error codes in order to track failure rates of several different failure modes.

In another example, the EC/EO film has been characterized as described, and the characterization information is stored in the logic and memory area of the RFA IC. In this way, each RFA IC holds information regarding the activation criteria required for that particular IC's EC/EO film. Some or all of this characterization information may be transmitted to the reader, and the reader may use the characterization information to adjust activation or deactivation processes. For example, the characterization information may provide an indication of how long it is expected to take for the film to fully activate. Using this information, the reader may shorten or lengthen the time period in which the reader expects an activation confirmation message. In another example, the reader may adjust RF power output according to the film characteristics. In this way, a particularly “slow” film may have a better chance for full activation if the reader transmits, for a short period of time, in a high-power mode. It will be appreciated that the reader may use the switch characterization information to make any of a number of adaptations. It will also be appreciated that the switch characterization information applies to non-EC/EO switches such as fuses and partial fuses. It will also be understood that the switch characterization information may provide detailed information regarding charge requirements, or may provide a more simplified classification. For example, the classification information may simply rate the switch as slow, normal, or fast. It will be understood that the classification information may take alternative forms.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

1. A method for confirming an optical disc has likely been activated, comprising:
monitoring for an amount of charge transferred into an optical shutter that is connected to the optical disc;
determining, responsive to the monitoring step, that the optical shutter has changed to an activated state; and
setting, responsive to the determining step, a signal indicating that the optical disc is to have been successfully activated.

2. The method according to claim 1, wherein the optical disc is a DVD, an HD-DVD, a Blu-ray disc, a software application disc, a gaming disc, or a CD.

3. The method according to claim 1, wherein the optical shutter is an electro-optic or electrochromic film, and the optical shutter is positioned in or on the optical disc.

4. The method according to claim 1, wherein changing the optical shutter to the activated state comprises transitioning the optical shutter: from an opaque state to a substantially clear state; from a substantially clear state to an opaque state; from a highly reflective state to a highly transparent state; or from a highly transparent state to a highly reflective state.

5. The method according to claim 1, wherein the monitoring step further comprises measuring the time period that a current flow exceeds a current threshold; and the determining step further comprises determining that the time period exceeds a time threshold.

6. The method according to claim 1, wherein the monitoring step further comprises integrating a current flow over a plurality of time intervals.

7. A method for confirming a likely change in activation state for a target, comprising:
monitoring for an amount of charge transferred into an electrically switchable device that is connected to the target, the electrically switchable device initially in a first state;
determining, responsive to the monitoring step, that the electrically switchable device has changed to a second state; and
setting, responsive to the determining step, a signal indicating the state of the switch.

8. The method according to claim 7, wherein the target is an optical disc, a DVD, an HD-DVD, a Blu-ray disc, a software application disc, a gaming disc, or a CD.

9. The method according to claim 7, wherein the electrically switchable device is an electro-optic or electrochromic film.

10. The method according to claim 7, wherein the target is an electric or electronic device, a portable music player, a television, a camera, an electric toothbrush, an electric razor, a drill, or an electric power tool.

11. The method according to claim 7, wherein the monitoring step further comprises measuring the time period that an applied voltage exceeds a voltage threshold; and the determining step further comprises determining that the time period exceeds a time threshold.

12. The method according to claim 7, wherein the monitoring step further comprises measuring the time period that a current flow exceeds a current threshold; and the determining step further comprises determining that the time period exceeds a time threshold.

13. The method according to claim 7, wherein the monitoring step further comprises measuring a current flow in a time period.

14. The method according to claim 13, further comprising the step of aggregating a plurality of time periods to determine a total charge transferred, each time period having an associated current flow.

15. The method according to claim 7, wherein the monitoring step further comprises integrating a current flow over a plurality of time intervals.

16. The method according to claim 15, wherein the time intervals are periodic.

17. The method according to claim 15, wherein the time intervals are variable.

18. The method according to claim 15, wherein the integrating step further comprises using an analog to digital conversion to quantize the current flow.

19. The method according to claim 15, wherein the determining step further comprises determining that current flow has fallen below a threshold for 1 or more time intervals.

20. An integrated circuit, comprising:
a connection to an electrically switchable material, the electrically switchable material setting an activation state for a target;
a memory holding electrical characterization information regarding the electrically switchable material;
a monitoring circuit arranged to monitoring for an amount of charge transferred into an electrically switchable device;
a logic configured to determine that the electrically switchable device has likely changed to a second state.

21. The integrated circuit according to claim 20, further including an output line for indicating that the switchable device has likely changed to the second state.

22. The integrated circuit according to claim 20, wherein the memory also holds a value indicative of an amount of charge transferred to the electrically switchable material.
